(19) United States
(12) Patent Application Publication
(10) Pub. No.: US 2004/0235433 A1
(43) Pub. Date: Nov. 25, 2004

(54) Determining transmit diversity order and branches

(75) Inventors: Klaus Hugl, Helsinki (FI); Juha Laurila, Espoo (FI); Werner Weichselberger, Wien (AT)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/732,854

(22) Filed: Dec. 11, 2003

(30) Foreign Application Priority Data
May 22, 2003 (FI) 20030777

(51) Int. Cl. H04B 1/02

(52) U.S. Cl. 455/101; 455/103

(57) ABSTRACT

The present invention relates to a method for determining transmit diversity order and branches for a transmitter having at least two transmit diversity branches. The transmit diversity branches for use are determined based on estimated channel properties of transmit diversity branches. A network element and a radio transmitter, where transmit diversity branches are determined using estimated channel properties, are also discussed.

### BACKGROUND OF THE INVENTION

1. Field of the Invention

The invention relates in general to transmission diversity in radio communication systems. The present invention relates in particular to determining transmit diversity order and transmit diversity branches for use, in other words to determining the number of transmission diversity branches and which transmission branches to use in a network element or a terminal for transmitting certain information over a radio link.

2. Description of the Related Art

Transmission diversity refers to sending information over more than one transmission branch, thus providing preferably statistically independent signals. Transmit diversity techniques have been utilized, for example, in mobile communication system for many years in order to mitigate the detrimental effects of fading caused by multipath propagation. Diversity techniques employ two or more spatially separated antennas, orthogonal polarizations or beams, that is to say angular diversity. Diversity may be based also on using different frequencies. The aim of separating the diversity branches has the following purpose: the signals of different diversity branches should be as uncorrelated as possible in order to maximize the achieved diversity.

If at least two uncorrelated signals carrying effectively the same information are received, it is probable that at least one of these diversity branch signals is not in a fading dip caused by fast fading due to multipath propagation. Therefore generally combining the received signals or selecting a best quality received signal provides a better quality signal than if only one signal were transmitted and received. The received signals may either be combined (diversity combining) or a strongest received signal may be selected (diversity selection).

To obtain diversity gain in cellular communication systems, transmission diversity may be used in the downlink direction from a base station to a mobile station and/or in the uplink direction from a mobile station to a base station. In prior art base stations a predetermined diversity scheme is usually defined: the number of diversity branches is predetermined, and the same diversity branches are used for all mobile stations. At most a decision on whether to use only one predetermined antenna or the predetermined diversity scheme is done dynamically. It is, however, common that this decision is made during network planning or refinement, and the transmit diversity scheme or the one predetermined antenna is then kept fixed during operation.

The location of a mobile station may strongly affect the fast fading and correlation of signals transmitted from a base station. It is possible that a small change in the mobile stations location causes the fading situation to change quite dramatically (but not the correlation properties). As discussed above, transmit diversity is used for compensating changes in fast fading, and it works when the received diversity order signals are uncorrelated. Significant changes in the location of the mobile station, e.g. in the order of a couple of tens of meters, may however change the correlation between the received transmit diversity signals. Adapting the transmission strategy to the changing channel situation can provide significant performance improvements.

The prior art base stations have at least two major disadvantages. As the diversity scheme is fixed during operation, the transmit diversity order cannot be adapted to changing channel situations. Therefore the chosen and fixed diversity order is suboptimum for most mobile stations. Furthermore, an experienced expert has to decide which transmit diversity order should be applied at a specific base station. This decision has to be done separately for each base station since it strongly depends on the surrounding environment. The network planning is normally based on network planning tools that do not take these issues into account. Therefore, the decision to use transmit diversity at all and which transmit diversity order to apply is not based on real propagation phenomena.

### SUMMARY OF INVENTION

It is an aim of embodiments of the present invention to address one or more of the problems discussed above.

According to a first aspect of the present invention there is provided a method for determining transmit diversity for a transmitter having at least two transmit diversity branches, the method comprising the step of determining at least one transmit diversity branch for use based on estimated channel properties of transmit diversity branches.

According to a second aspect of the present invention there is provided a network element for use in transmit diversity, the network element comprising means for establishing estimated channel properties of at least two transmit diversity branches, and means for determining transmit diversity branches for use based on estimated channel properties.

According to a third aspect of the present invention there is provided a radio transmitter having at least two transmit diversity branches, the radio transmitter comprising means for establishing estimated channel properties of at least two transmit diversity branches, and means for determining transmit diversity branches for use based on estimated channel properties.

Some embodiments of the invention may have at least the following advantages. As estimated channel properties of the transmit diversity branches are used in determining transmit diversity branches, the transmit diversity order can be adapted to the current situation of a communication link. Therefore the applied transmit diversity order and the utilized transmit diversity branch set may be changed during the operation of a communication link, and the transmit diversity order and/or the selected branches may be different for different receivers and different receiver positions.

Furthermore, it is possible in some embodiments of the invention to automate the selection of transmit diversity order and the transmit diversity branches for a communication link, as the transmit diversity branch and order selection is based on the estimated channel properties of the available diversity branches. No human intervention is needed for determining the transmit diversity order and/or branches for use. This provides support for the implementation of self-configurable mobile radio network elements and networks.

The estimated channel properties are in some embodiments of the invention expected powers of the transmit diversity branches and in some other embodiments of the invention second order statistics of the channel coefficients of the transmit diversity branches.

The described selection of transmit diversity order and transmit diversity branches is applicable to any transmission diversity concept, for example to spatial, polarization, angular or frequency diversity. It is also applicable in systems employing either time division duplex (TDD) or frequency division duplex (FDD).

For some transmit diversity techniques, the receiver need not be aware that the transmit diversity order and branch selection in embodying the invention is applied in the transmitting end. If the diversity scheme applied in a communication network or specifications relating to the communication network otherwise expects a receiver to be informed about the transmit diversity order and/or the utilized transmit diversity branches, the receiver may be informed about the applied transmit diversity.

### BRIEF DESCRIPTION OF DRAWINGS

For a better understanding of the present invention and as how the same may be carried into effect, reference will now be made by way of example only to the accompanying drawings in which:

FIG. 1 shows one example of a system in which embodiments of the present invention can be implemented;

FIG. 2 shows a flowchart of a method in accordance with a first embodiment of the invention;

FIG. 3 shows a search tree for a method in accordance with a first embodiment of the invention;

FIG. 4 shows a search tree with reduced complexity for a method in accordance with a first embodiment of the invention;

FIG. 5 shows a flowchart of a method in accordance with a second embodiment of the invention;

FIG. 6 shows a diversity transmitter applying phase hopping and delayed transmission;

FIG. 7A shows a diversity transmitter in accordance with a first embodiment of the invention

FIG. 7B shows a diversity transmitter in accordance with a fourth embodiment of the invention; and

FIG. 8 shows a flowchart of a method implemented in the transmission arrangements of FIGS. 7A and 7B.

### DETAILED DESCRIPTION OF THE PREFERRED EMBODIMENTS

The embodiments of this invention are in general applicable in wireless point-to-point systems using more than one transmission branch, for example in a wireless local area network (WLAN) or in a cellular mobile telecommunications system. Moreover, this invention can be utilized at both ends of a communication link, that is at the base station and/or at the mobile station in case of cellular mobile communication systems. Throughout this description, the application of the invention especially at a cellular base station is discussed, but the invention is not restricted to this example. It is applicable in any transmitter having at least two transmission branches. In connection with a cellular mobile system, the embodiments of the invention are applicable also in a mobile station having at least two transmission branches. In a WLAN, the embodiments of the invention are applicable to access points and to user equipment.

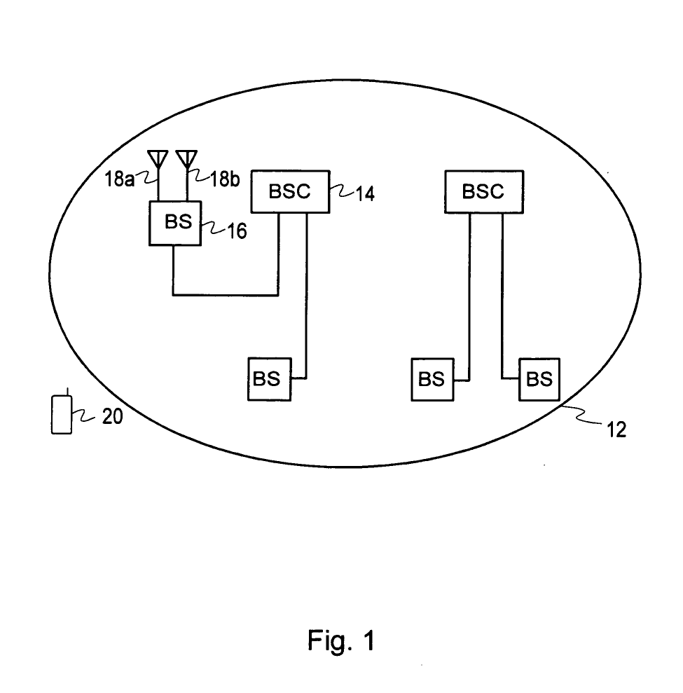

FIG. 1 illustrates as an example of a system, where embodiments of the invention may be applied, a radio access network 12 of a cellular mobile communication system. The radio access network 12 has a plurality of base station controllers (BSC) 14. A base station controller 14 may control a plurality of base stations (BS) 16, which are typically connected to a base station controller with a fixed line connection or, for example, with a point-to-point radio or microwave link. A base station controller 14 is responsible for controlling and managing the radio resources in a base station 16. Depending on the specifications, the names of the network elements may differ. In GSM (Global System for Mobile communications) system a network element corresponding to a base station is called base transceiver station (BTS). In UMTS (Universal Mobile Telecommunications System), for example, a network element corresponding to a base station is called node B, and node B elements are controlled by a radio network controller RNC. The terms used in this document are intended to cover these variants, but embodiments of the invention are applicable also to other transmitters as mentioned above.

A base station 16, which is able to support transmit diversity, comprises at least two transmit diversity branches. In FIG. 1 these transmit diversity branches are illustrated as two spatially separated antennas 18a, 18b. As is well known, transmit diversity may be alternatively spatial diversity, polarization diversity, angular diversity, or frequency diversity. The transmit diversity order and branch selection in accordance with the invention is usually carried out in the base station controller 14 but may in alternative embodiments of the invention be determined in the base station or any other suitable entity. The signal processing generally relating to different transmit diversity branches is usually carried out in the base station 16. The transmit diversity signals are then transmitted from a base station 16.

A mobile station 20 communicates with the base station 16 over a radio interface. The mobile station 20 receives transmit diversity signals transmitted from the base station, and performs diversity combining or selection when processing the received signals.

As discussed above, changes in the location of a transmitter or receiver or, on the other hand, changes in the environment affecting the signal propagation from the transmitter to the receiver affect the effectiveness of transmit diversity. In order to determine an optimum transmit diversity order for a communication link in accordance with an embodiment of the invention, some information about the radio channel is needed. Most communication systems, including Global System for Mobile communications (GSM) and Universal Mobile Telecommunication System (UMTS), utilize training sequences in the data streams or separate pilot signals to enable robust channel estimation.

Although the instantaneous radio channel can change very rapidly, the statistical properties of the channel may be assumed to be rather constant for small movements of a receiver or a transmitter. The second order statistics of the channel describe the properties of the radio environment on average, i.e. they are not affected by small scale fading. The second order statistics comprise the average channel gains and the correlations between the channel coefficients of different diversity branches. They are completely described by the correlation matrix of the channel coefficients of the diversity branches.

In statistics, correlation is a measure of the association between two variables. Its absolute value is between 0 and 1. A correlation value of zero indicates no relationship between the data sets. A correlation value of 1 denotes identical replicas.

It is well known that correlation of diversity branches deteriorates the performance of transmit (or reception) diversity. It should be noted, however, that the level of correlation, where this deterioration becomes relevant, depends on the communication system and its requirements. Typically a correlation coefficient value smaller than 0.4 indicates irrelevant deterioration, and the diversity branches can be considered to be efficiently uncorrelated. In some systems the requirements may be stricter, and correlation coefficient values smaller than 0.2 can be interpreted as efficiently uncorrelated diversity branches. In this specification, apart from diversity branches corresponding to Eigenvectors (see below), correlated and uncorrelated diversity branches generally mean efficiently correlated and efficiently uncorrelated diversity branches.

In the following, a channel model is used to explain the estimation of the channel statistics. A transmitted signal travels via several multipath components to a receiver. A multipath component is defined discrete in space and time. The channel h of a specific user at delay h is a superposition of all impinging multipath components at delay τ:

$$h [ n , τ ] = {\sum }_{j = 1}^{{J}_{τ}} [ \begin{matrix}{α}_{τ , j , 1} [ n ] \\ {α}_{τ , j , 2} [ n ] \\ ⋮ \\ {α}_{τ , j , M} [ n ]\end{matrix} ]$$

where α_{τ,j,m} denotes the complex channel coefficient of the m-th diversity branch of the j-th multipath component for delay τ. Herein, index n denotes the discrete time, and J_{τ} is the number of multipath components with delay τ. Thus, the channel h[n,τ] is a vector containing the channel coefficients of all M diversity branches at a specific delay τ and time instant n. Here a channel coefficient refers to the complex amplitude of a single delay tap at a single diversity branch of the radio signal after traveling through a radio channel. Alternatively, a channel coefficient may be defined in the frequency domain instead of the delay domain. A channel coefficient is thus a complex scalar. A channel impulse response for a diversity branch is a vector of channel coefficients of all delay taps or frequency bins. For more than one diversity branch, the channel impulse response becomes a matrix. A channel impulse response is a complete response of a channel when excited by a Dirac impulse. Correlation is to be taken with respect to channel coefficients, not with respect to channel impulse responses.

The received signal of this specific user thus reads as:

$$x [ n ] = {\sum }_{τ = 0}^{D - 1} h [ n , τ ] s [ n - τ ]$$

where s is the transmitted signal of the specific user and D is the number of delay taps of the specific user.

Utilizing the above entities, it is possible to define the following correlation matrix, where the expectation operator is substituted by the average in the delay and time domains:

$$R [ {n}_{0} ] = \frac{1}{D \cdot N} {\sum }_{n = {n}_{0}}^{{n}_{0} + N - 1} {\sum }_{τ = 0}^{D - 1} h [ n , τ ] {h}^{H} [ n , τ ]$$

where N is a number of temporal snapshots and (·)^{H} denotes the hermitian transpose (complex conjugate transpose).

The average power that is transported over a specific channel, i.e. the average channel gain, is defined as the average of the squares of the amplitudes of the channel coefficients. Because the second order statistics are assumed to be stationary, the expected channel gain for future transmissions is given by the average channel gain. The channel gains of the M transmit/receive branches (denoted by λₘ) form the diagonal elements of the correlation matrix, which are defined as

$${λ}_{m} [ {n}_{0} ] = {R}_{m m} [ {n}_{0} ] = \frac{1}{D \cdot N} {\sum }_{n = {n}_{0}}^{{n}_{0} + N - 1} {\sum }_{τ = 0}^{D - 1} {h}_{m} [ n , τ ] {h}_{m}^{*} [ n , τ ] ,$$

where (·)* denotes the complex conjugate. If the signals on the M branches are totally uncorrelated, then the correlation matrix becomes a diagonal matrix.

A correlation matrix of size M×M can be mathematically decomposed into a weighted sum of M Hermitian matrices of rank 1. The weights uₘ of this sum are the Eigenvalues of the correlation matrix.

$$R = {\sum }_{m = 1}^{M} {u}_{m} {v}_{m} {v}_{m}^{H}$$

Filtering the signals on the multiple diversity branches by the Eigenvectors vₘ yields perfectly uncorrelated fading coefficients. The Eigenvalues uₘ denote the average power of these uncorrelated signal parts.

In the case of uncorrelated diversity branches, the Eigenvalues uₘ of the correlation matrix R correspond to the expected powers of the M diversity branches. In the case of correlated diversity branches, an Eigenvalue uₘ of the correlation matrix R corresponds to the expected power of the corresponding Eigenvector.

The channel correlation matrix can be estimated by averaging over a suitable time period, as described above. This averaging period should be long enough to provide a good estimate of the expected channel statistics by averaging out small-scale fading effects, and short enough to adapt to the current channel situation.

It should be appreciated that the embodiments of the present invention do not need instantaneous channel coefficients or channels impulse responses. It is sufficient to have some relatively recent values of channel coefficients or channel impulse responses for averaging the channel powers or correlation coefficient matrices.

It is possible to acquire statistical information about channel coefficients of diversity branches either in the transmit direction or in the receive direction. First, statistical channel information can be estimated in the reception direction and then utilized for the transmit direction. Because the second order statistics are not affected by small scale fading, they may be assumed to be the same for links at both transmit and reception directions, for example for both uplink and downlink. In FDD systems it may be necessary to transform frequency dependent parameters, as is known to a person skilled in the art.

Second, the channel statistics may be estimated at the receiver side and then fed back to the transmitter. As the statistics change rather slowly, the delay due to the feedback is not of much concern. An advantage of this second option is that the obtained channel statistics information may be more accurate than in the first option.

The first option is more favorable in systems, where consumption of radio resources for feedback is undesirable. Furthermore, in the first option mobile stations or other receivers need not be adapted for the second order statistics calculations, which may need increased computational capabilities at the mobile station. The feedback of channel statistics may require also modifications to standard specifications relating to a communication system. To enable a receiver to estimate each diversity channel separately, each transmit branch may have to send a distinct training sequence or pilot signal. In order to enable a good quality channel estimation it is typically necessary that these training sequences are orthogonal, either in time, code or another domain. Moreover, this would require pilot signals transmitted from each of the possible diversity branches to enable channel estimation at the receiver for each of these branches also if they are not utilized for diversity transmission. The quantization of the statistical information, which is necessary for the feedback transmission, may reduce the accuracy of the channel statistics.

Either the first or the second option for acquiring channel properties is suitable for any specific procedure for selecting the transmit diversity order and for selecting transmit diversity branches for use.

Because the channel gain should preferably be as high as possible, those diversity branches carrying high power are advantageously preferred to those with less power. In the case of uncorrelated diversity branches, a number of strongest branches is preferably used in transmit diversity. In the case of correlated diversity branches, the Eigenvectors of the correlation matrix R can be used as transmit weights in order to create virtual transmission branches showing uncorrelated channel coefficients. The average channel gains of these virtual transmission branches are given by the corresponding Eigenvalues. Therefore, a number of Eigenvectors corresponding to the strongest Eigenvalues are preferably utilized as virtual transmission branches.

In some communication system designs, the diversity branches cannot be created arbitrarily but are predefined. Two examples of reasons for this restriction are the following. First, a transmitter design may be restricted to fixed diversity branches due to robustness and simplicity. For an antenna array, this means restriction to fixed antennas or fixed beams, and for polarization diversity this means that different polarization branches can be used only as such, linear combinations of polarization branches are not possible. In the case of frequency diversity with a fixed carrier frequency this is the only possibility. Secondly, technical standardization of a communication system may impose a restriction not to create arbitrary diversity branches.

Consider, for example, the UMTS FDD system, which shows a combination of the two reasons above. The UMTS FDD standard defines common pilot channels that are mainly used for channel estimation purposes at a mobile receiver in the downlink. Although there are also dedicated pilot bits in the data stream of each individual user, the pilot channels offer a much larger correlation length and enable a more robust channel estimation. Transmitting a separate secondary pilot for each user (which is possible in theory) would lead to large overhead in power consumption and create additional intra-cell interference. Thus in UMTS FDD system, it is reasonable to use only a limited and fixed set of possible diversity branches. On each fixed diversity branch, a secondary common pilot channel is transmitted for channel estimation. This way the power overhead is kept low, the channel estimation is enhanced by pilot channels, and beamforming and angular diversity is possible by means of fixed beams.

The problem of selecting the transmit diversity order and the transmit diversity branch set for efficiently correlated or uncorrelated diversity branches is addressed next. In order to achieve a desired bit-error-rate (BER) the received signal power need be sufficiently high. An outage occurs when the received signal power falls below a certain threshold, which depends on the target BER. The tolerable outage probability is defined by the desired quality-of-service (QoS) of the communication link. The outage probability is decreased by a high channel gain and a high diversity order.

Usually diversity branches show different channel gains. Therefore, the average channel gain and diversity order cannot be chosen independently, as they contradict each other. A higher diversity order causes a lower channel gain and vice versa, assuming the same total transmit power. A suitable trade-off between the channel gain and the diversity order depends on the current channel situation, on the QoS requirements and on the available transmit diversity branches. The problem is thus to adapt the diversity order and select the transmission branches so that the transmission becomes sufficiently good, or preferably near optimum, for a current channel situation.

To determine whether a transmission is sufficiently good, a proper means for describing the quality of a communication link is needed. The theoretically achievable data rate of a radio link can be associated with the ergodic capacity of the radio link. It is nearly independent of the fading statistic, and cannot therefore be enhanced by diversity. It is, however, not enough to provide as high data rate as possible. A data rate has to be provided rather continuously and with a certain reliability. The outage capacity is a proper means for quantifying data rate, reliability and continuity of a radio link.

The outage capacity is a statistical entity, which is parameterized by a certain signal-to-noise (SNR) threshold and an outage probability. For a given SNR threshold γ₀ and for a given outage probability F₀, the outage capacity Cₒᵤₜ(γ₀, F₀) specifies the data rate which can be guaranteed with probability (1−F₀). The SNR at the receiver depends on the radio channel and the transmit power.

For a given communications system, such as GSM or UMTS, some of the above parameters are predefined. A specific service may define the data rate, modulation schemes and also the desired outage probability. The data rate in conjunction with the applied receiver defines the necessary receive SNR.

In transmission diversity—at least in the case of uncorrelated diversity branches—at least the diversity branch having the largest expected power is advantageously used. Starting from certain assumptions, it is possible to derive a transmit diversity performance indicator reflecting the efficiency of a transmit diversity branch set. Furthermore, for uncorrelated diversity branches it may be possible to derive a power threshold criterion for using a further, next strongest transmit diversity branch in transmit diversity.

Let us define μ_{Θ} as the transmit diversity performance indicator of the diversity branch combination Θ. The set Θ contains the indices of the k used diversity branches.

We denote the vector of channel coefficients for the set Θ as

$${h}_{Θ} [ n , τ ] = [ \begin{matrix}{h}_{{θ}_{1}} [ n , τ ] \\ {h}_{{θ}_{2}} [ n , τ ] \\ ⋮ \\ {h}_{{θ}_{k}} [ n , τ ]\end{matrix} ] ; Θ = \{ {θ}_{1} , {θ}_{2} , … , {θ}_{k} \} ,$$

and the corresponding channel correlation matrix as

$${R}_{Θ} [ {n}_{0} ] = \frac{1}{D \cdot N} {\sum }_{n = {n}_{0}}^{{n}_{0} + N - 1} {\sum }_{τ = 0}^{D - 1} {h}_{Θ} [ n , τ ] {h}_{Θ}^{H} [ n , τ ] .$$

The Eigenvalues of R_{Θ} are labelled as uₘ. Using above definitions, we define μ_{Θ} as

$${μ}_{Θ} = \sqrt[\vert Θ \vert]{{F}_{0} {\prod }_{m = 1}^{\vert Θ \vert} {u}_{m}} ,$$

where F₀ denotes the required outage probability and Θ=k is the number of diversity branch indices in the set Θ.

Now, the largest possible μ_{Θ} defines the optimum set Θₒₚₜ of diversity branches:

$${Θ}_{opt} = arg {max}_{Θ} {μ}_{Θ} .$$

This formula for the transmit diversity performance indicator can be derived by numerical simulations for Rayleigh fading. For specific coding schemes of specific communication systems the formulation of the transmit diversity performance indicator may be adapted to the specific application.

The use of this diversity performance indicator in selecting the transmit diversity order and branches is illustrated by the embodiments below.

A first embodiment of the invention is suitable especially for fixed transmission diversity branches, that is for transmitters where linear combinations of the branches are not possible. Examples of such fixed diversity branches are fixed beams with an antenna array. The transmit diversity branches are utilized as they are given by the physical branch setup, for example polarized antennas, spatially separated antennas or diversity transmission on different frequencies. In the first embodiment of the invention, the correlation between the possible branches is taken into account which means that the transmit diversity order and branch selection works even when the branches are not efficiently uncorrelated.

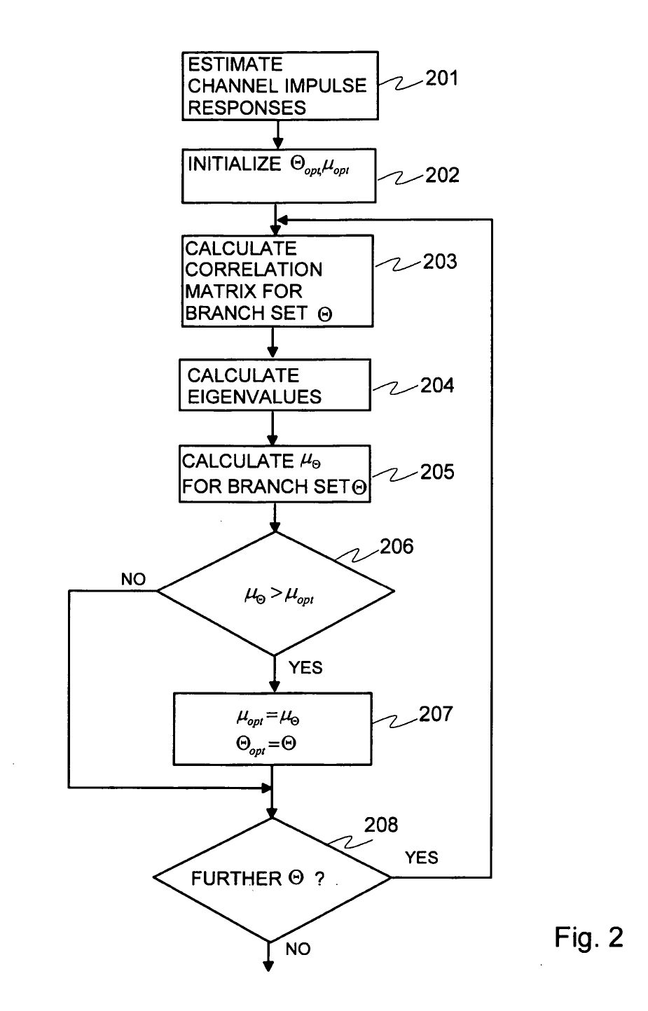

FIG. 2 illustrates a flow chart of the method in accordance with the first embodiment. In step 201 channel impulse responses for diversity branches are estimated. In step 202 the search for an optimal diversity performance indicator is initialized by setting Θₒₚₜ={ } and μₒₚₜ=0. In steps 203-207 the diversity performance indicator μ_{Θ} is calculated, combination by combination, for all potential diversity branch combinations using the Eigenvalues of the corresponding channel correlation matrix. In step 203 a correlation matrix for a diversity branch set Θ is calculated. In step 204 the Eigenvalues of this correlation matrix are calculated, and in step 205 the performance indicator is calculated for the current diversity branch combination. In step 206 the performance indicator calculated in step 205 is compared with the previous highest performance indicator. If the latest performance indicator exceeds the previous highest indicator the optimal candidate set and optimal diversity performance indicator are updated in step 207. Steps 203-206 are repeated until all potential combinations of diversity branches have been studied (step 208).

In this first embodiment of the invention, all potential diversity branch combinations are evaluated. In the following an enhancement of this first embodiment is discussed; the enhancement reduces computational load.

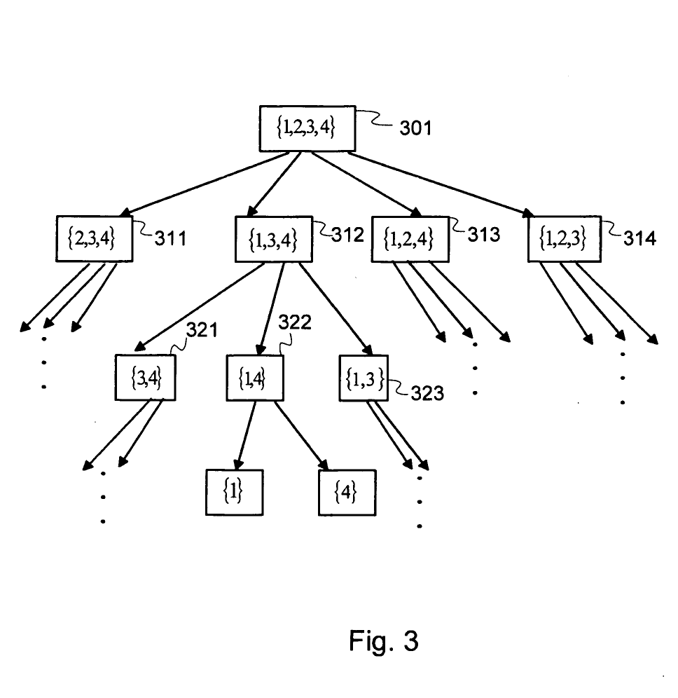

The basic idea in this enhancement of the first embodiment is to step through all possible branch combinations by means of a tree search and to neglect specific irrelevant branches of the tree. FIG. 3 shows, as an example, a search tree for a case, where there are four diversity branches. The root node 301 of the search tree, that is the starting set for the search, is a full set consisting of all diversity branches. In FIG. 3 this full set is {1, 2, 3, 4}. Further nodes of the search tree are generated by removing one diversity branch from a set in a parent node. In FIG. 3, for example, the search tree has four nodes 311, 312, 313 and 314 in the first level. These four search tree nodes correspond to sets {2, 3, 4}, {1, 3, 4}, {1, 2, 4} and {1, 2, 3}. If there are M diversity branches in total, the root of the search tree is the set {1, 2, . . . ,M}, and there are M branches going to the sets {2, 3, . . . ,M}, {1, 3, . . . ,M}, . . . , {1, 2, . . . ,M−1}. The nodes on further levels are generated similarly from their parent nodes. See, as an example, nodes 321, 322 and 323 of parent node 312 in FIG. 3. Obviously, apart from the diversity branch set corresponding to the root node, there are multiple copies of each diversity branch set present in the tree. However, the performance indicator μ_{Θ} for the multiple sets need to be calculated only once.

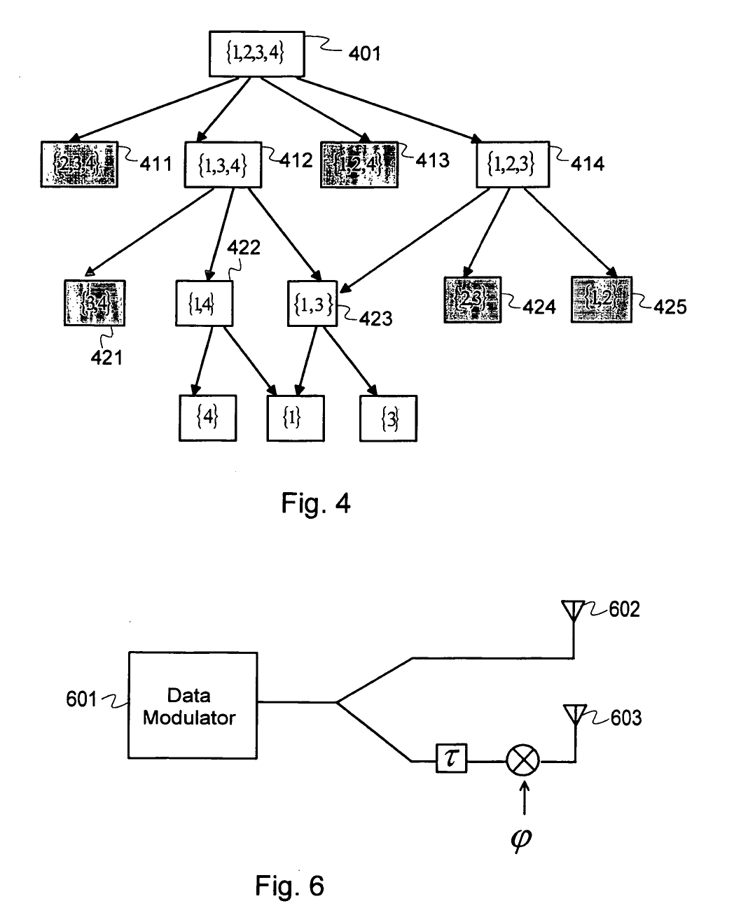

To reduce the computational complexity the following can be done. If a diversity branch set corresponding to any node of the tree has a performance indicator μ_{Θ} that is smaller than the corresponding μ_{Θ} of the parent node, i.e. the generating higher level node, then this node and all nodes connected to this node can be neglected. This means that μ_{Θ} need not be calculated for these nodes. FIG. 4 illustrates this methodology. Each node 411, 413, 421, 424 and 425 marked in grey has a μ_{Θ} smaller than its parent node and therefore this tree-path is neglected. Moreover, in FIG. 4 there exist connections between the search tree branches which illustrate the multiple copies of the subsets of the different trees that do not have to be check and calculated several times. See, for example, node 423, which is a child for both node 412 and node 414.

A second embodiment of the invention is suitable especially for efficiently uncorrelated transmit diversity branches. As stated already earlier, in the case of uncorrelated branches the correlation matrix becomes diagonal and the Eigenvalues uₘ of the correlation matrix correspond to the average powers of the diversity branches. Let us now denote the branch power of the m-th diversity branch with λₘ. As a consequence, the diversity performance indicator can be formulated using the branch powers directly. Let us consider now the case of M diversity branches and assume the diversity branches are ordered with descending expected powers: λ₁>λ₂> . . . >λ_{M}. The diversity performance indicator for the k strongest diversity branches can be written as

$${μ}_{k} = \sqrt[k]{{F}_{0} {\prod }_{m = 1}^{k} {λ}_{m}} .$$

Starting with the strongest diversity branch only, we calculate μ₁. Then, the performance criterion for the two strongest branches is compared to Ha: the second branch is utilized for transmission if μ₂>μ₁. This procedure can be generalized to an iterative approach: We utilize the (k+1)-th diversity branch if μ₍ₖ₊₁₎>μₖ. If μ₍ₖ₊₁₎<μₖ then the iterations are stopped. Using the recursive definition of μₖ,

$${μ}_{k} = \sqrt[k]{{( {μ}_{k - 1} )}^{k - 1} {λ}_{m}} ,$$

the condition for utilizing the (k+1)-th diversity branch can be reformulated as λₖ₊₁>μₖ.

Thus, in the case of uncorrelated fixed diversity branches the diversity performance indicator can be understood as a power threshold an additional diversity branch has to exceed to be utilized as transmission diversity branch. The diversity order and branch selection can be started from the strongest diversity branch and check if using the next strongest diversity branch increases the performance indicator. This means that for uncorrelated fixed diversity branches the selection algorithm is a step-wise operation instead of a full search of all possible transmission diversity branch sets. Therefore, at maximum M−1 different diversity performance indicators need to be calculated. The diversity performance indicator is denoted as a power threshold in this respect.

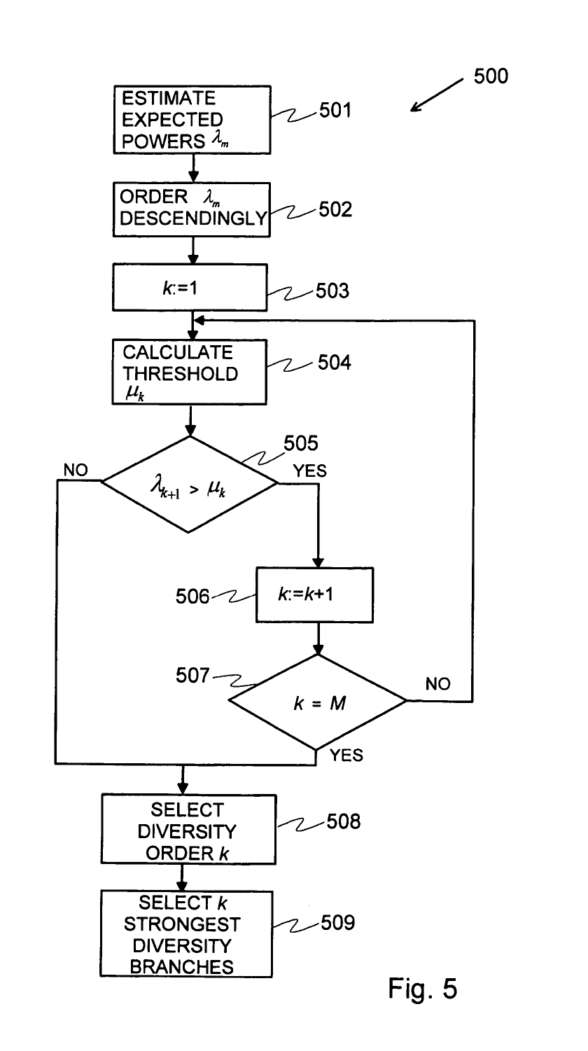

FIG. 5 illustrates a flowchart of a method 500 in accordance with the second embodiment using the power threshold. The number of available transmit diversity branches is M. In step 501, the expected powers of the M diversity branches are estimated by averaging the power of the same diversity branch in the receive direction over a suitable time period. Alternatively, it would be possible to estimate the expected powers by averaging the power of the diversity branch in the transmit direction with the assistance of a receiver. In step 502, the available transmit diversity branches are ordered descendingly according to their expected power: λ₁>λ₂> . . . >λ_{M}. In step 503 index k is initialized: k=1. In step 504, the power threshold μₖ is calculated. In step 505, it is determined whether λₖ₊₁>μₖ. If λₖ₊₁>μₖ then index k is incremented in step 506 by one and the power threshold is calculated again in step 504. If λₖ₊₁≦μₖ in step 505 or the incremented k equals to M in step 507, the diversity order is selected to be k in step 508. In step 509 the k strongest transmit diversity branches are selected to a transmit diversity branch set for transmitting information.

In this second embodiment the diversity performance indicator is used as a power threshold and calculated using the formula based on Rayleigh fading and no channel coding. Please note that dependent on the utilized coding scheme and communication system other power thresholds can be defined according to numerical simulations. Starting from other assumptions, it may be the case that a power threshold cannot be expressed as a suitable formula; in this case it is possible to use a transmit diversity performance indicator dependent on expected powers γₘ, and evaluate the transmit diversity performance indicator for various possible transmit diversity branch combinations similarly as in the first embodiment. The second embodiment is suitable in many situations, when the transmit diversity signals show low correlation.

A third embodiment of the invention is applicable, when the physical transmit diversity branches are efficiently correlated and it is possible to create virtual transmit branches by forming linear combinations of physical transmit diversity branches, the linear combination corresponding to the Eigenvectors of the correlation matrix. The signals of the subspaces spanned by the Eigenvectors of a correlation matrix are uncorrelated. Therefore, it is possible to apply the power threshold to the Eigenvalues of the correlation matrix, similarly as the power threshold is applied to the estimated powers in the second embodiment of the invention. The Eigenvectors define the virtual transmit branches which correspond to linear combinations of the available physical branches (e.g. antennas). In the case of an antenna array this linear combination refers to beamforming. In this third embodiment, the estimated channel impulse responses are used to calculate the correlation matrix R. Thereafter the Eigenvalues uₘ of the correlation matrix are calculated and used in steps 502-509 as virtual branch power values. The Eigenvectors of the resulting k largest Eigenvalues are selected for transmission and utilized as virtual transmission branches.

Consider next a base station. In a basic base station, the modulated data is directly transmitted by a single antenna element in the downlink. Multi-path propagation causes a fading signal to be received at a mobile station.

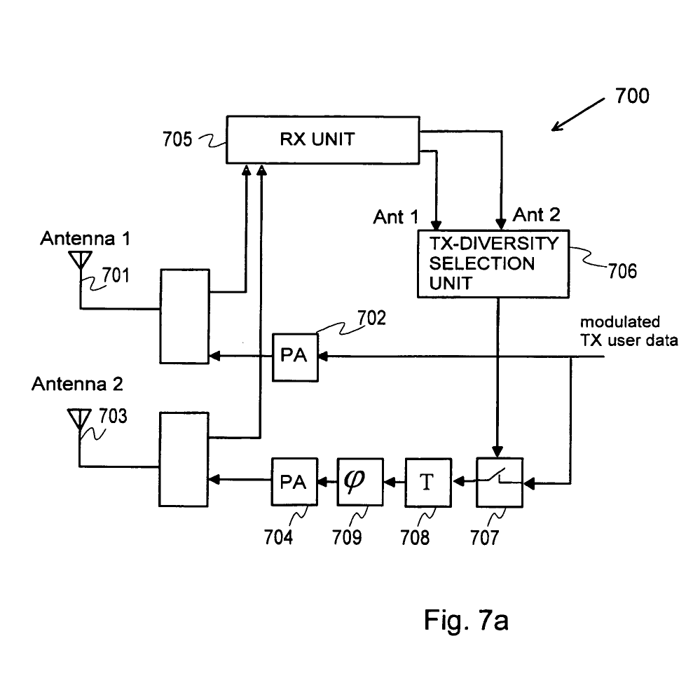

It is possible to overcome problems due to small-scale fading by downlink transmit diversity. As an example it is possible to use a transmit diversity scheme employing delay transmission and phase hopping as illustrated in FIG. 6. A modulated signal from a data modulator 601 is transmitted from two antennas 602, 603. The transmitted signal of the second antenna 603 is a delayed (by delay τ) and phase rotated version (by phase φ) of the signal at the first antenna 602.

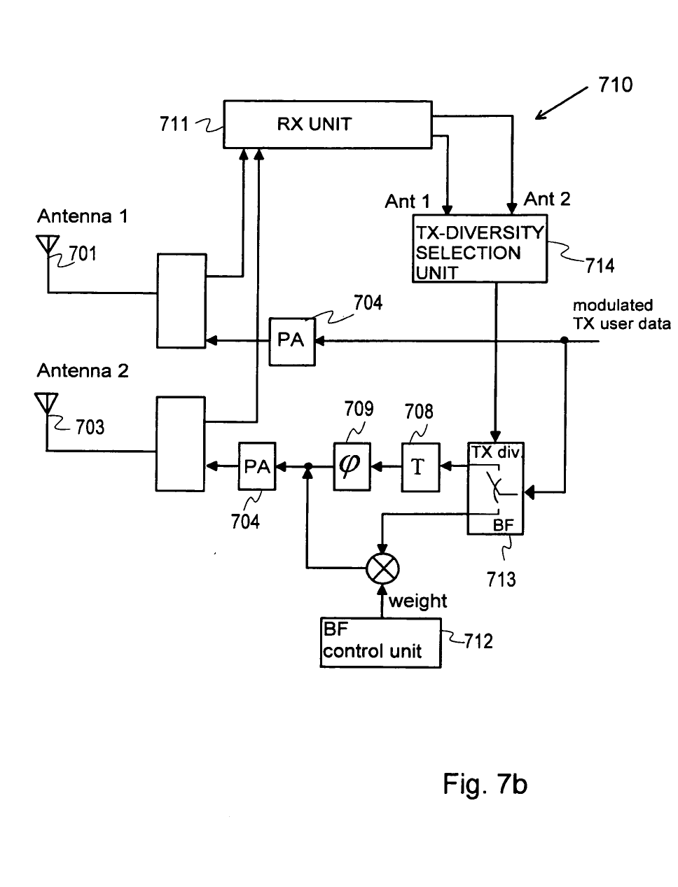

FIG. 7A illustrates a block diagram of this transmit arrangement 700 comprising a first antenna 701, a power amplifier 702 relating to the first antenna, a second antenna 703 and a power amplifier 704 relating to the second antenna. The antennas are connected to a receiving unit 705, where the received signals are processed and channel property estimates are performed. The channel property estimates are input to a transmit diversity selection unit 706, where a decision on using transmission diversity is made. A switching unit 707 is responsive to the output of the transmit diversity selection unit 706. Please note, that this switching unit does not need to be implemented in hardware. This may be implemented easily in software so that embodiments of this invention do not require any kind of hardware modifications. When the switch in the switching unit 707 is open, a decision for not using transmission diversity has been made, and a signal carrying the information to be transmitted is transmitted via the first antenna 701. When a decision to use transmission diversity is made, the switch in the switching unit 706 is on and a delayed (delay unit 708) and phase rotated (phase rotation unit 709) signal corresponding to the information to be transmitted is sent also from the second antenna 703. The transmit diversity selection unit 706 may be based on a correlation matrix calculated using estimated channel impulse responses or on estimated channel powers. Although the transmission arrangement in FIG. 7A is such that a selection is made between using a fixed single antenna (the first antenna 501) and transmit diversity using the first and the second antennas 501, 502, in accordance with other embodiments of the invention it is possible to select—in the case of a single antenna—the stronger antenna.

Transmission diversity performs well in the case of uncorrelated antenna branches—but in the case of correlated channels the performance may be worse than single antenna transmission. The reasons might be, firstly, the produced intersymbol interference, where two consecutively transmitted bits interfere with each other because of the delayed transmission of the second branch, and secondly that no diversity gain is achieved due to the correlated channels. Therefore, in some embodiments of the invention, the transmission diversity scheme illustrated in FIG. 7A should not be used in correlated channels. Transmit beamforming, on the other hand, relies on coherent combining of signals, which is only possible with correlated channels.

In a fourth embodiment of the invention, there is a selection between transmission diversity and beamforming. FIG. 7B illustrates a block diagram of an transmit arrangement 710, where a selection between transmission diversity utilizing phase hopping in combination with delayed transmission, and beamforming is made. The arrangement 710 comprises similar antennas 701, 703; power amplifiers 702, 704; and receiving unit 705 as the arrangement 700.

For diversity transmission the arrangement 710 comprises a delay unit 708 and a phase rotation unit 709. For beamforming the arrangement 710 comprises a beamforming control unit 712 outputting weights. By the weights, i.e. by adjusting at least phase and optionally also amplitude, the beam is directed to the main direction of the received signal.

In arrangement 710 the transmission diversity selection unit 714 makes a selection between using beamforming or transmission diversity. In both these cases the signal is transmitted using both antennas 701 and 702. In other embodiments of the invention it is possible that a transmitter has more transmit diversity branches than two. In such the selection unit may further select transmission diversity order, which is higher than two.

The arrangement 710 further comprises a switching unit 713 for selecting between diversity transmission and beamforming, the switch 713 being responsive to the selection signal from the transmit diversity selection unit 714. This switching unit can be easily implemented in software and therefore, may not need any kind of hardware modifications. If the arrangement comprises more than two antennas or diversity branches, the switching unit may be implemented to provide switching of the signal to be transmitted to any combination of these branches for transmit diversity. More than two antennas may also be used for beamforming.

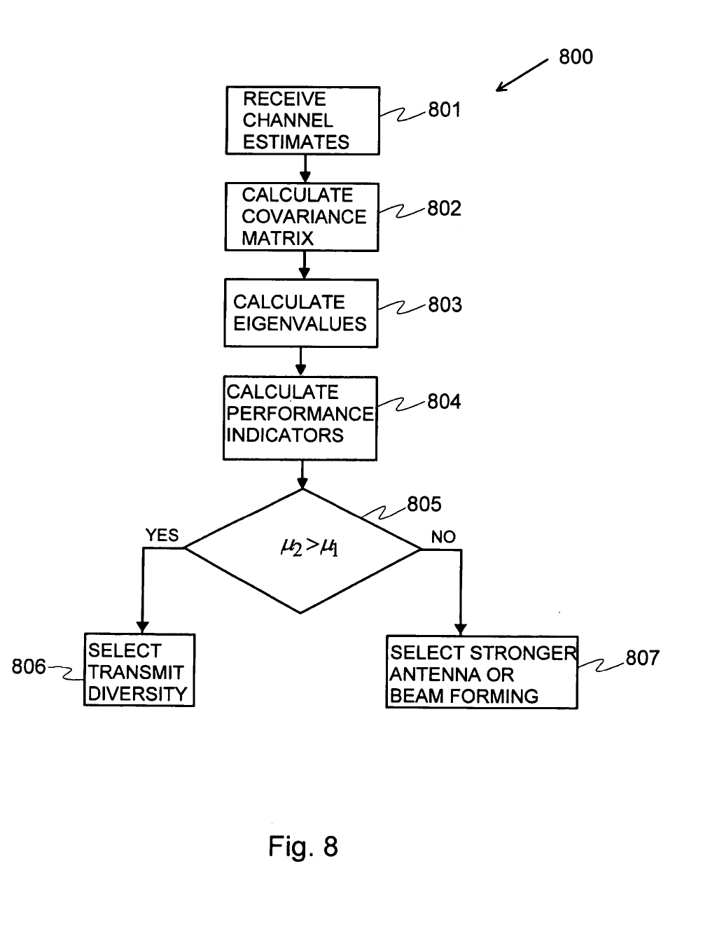

FIG. 8 illustrates a flowchart of a method 800, which can be implemented in the transmit diversity selection unit 706 of an arrangement 700. In this method 800, the number of antennas (transmit diversity branches) is two, and therefore the method has only one step for calculating a covariance matrix.

In method 800, channel impulse response estimates corresponding to the antennas 1 and 2 are received in step 801. In step 802 a correlation matrix is calculated using the channel impulse response estimates. The Eigenvalues of the correlation matrix are calculated in step 803. In step 804 the diversity performance indicators μ₁ and μ₂ are calculated. μ₁ denotes the performance of the system with antenna 1 only, i.e. it is calculated by means of λ₁, the mean power of antenna 1. Because μ₂ depends on both antennas and their correlation, μ₂ is calculated using the Eigenvalues μ₁ and μ₂ of the correlation matrix. In step 805 the two performance indicators are compared to each other. If μ₂ is larger than μ₁, then a decision to use diversity transmission is made in step 806. If μ₂ is smaller than or equal to μ₁, then in step 807 only the stronger antenna (no transmit diversity) is used (arrangement 700).

For arrangement 710, the situation is slightly different. In the non-diversity case, beamforming is used instead of single antenna transmission. Thus, in arrangement 710, the first performance indicator μ₁ has to be calculated by means of the average power of the virtual transmit branch, i.e. the beam formed by the beamforming control unit 712. The second indicator μ₂ is calculated in the same way as for arrangement 700. If μ₁>μ₂ then beamforming is applied instead of transmit diversity.

The arrangements 700, 710, or a similar arrangement in accordance with other embodiments of the invention may be implemented in a base station. In alternative embodiments part or all of the arrangement 700 or 710 may be implemented in a base station controller or any other suitable entity. Alternatively an arrangement in accordance with an embodiment of the invention may be implemented in a mobile station or in any other radio transmitter having at least two diversity branches.

When either the arrangement 700 or 710 is present in a cellular network, the following usually occurs. A base station BS starts the communication with a mobile station MS in the downlink using in the beginning single antenna transmission or transmission diversity. During the call setup the BS collects the statistics of the mobile radio channel during uplink reception. It calculates the correlation matrix and decides depending on the correlation and the power distribution of the diversity branches (on the Eigenvalue distribution of the correlation matrix), if to switch transmission diversity on or off for that specific user or to not change the configuration. The BS typically continues checking the statistics of the mobile radio channel to be able to react on changes of the propagation conditions. If necessary transmission diversity is switched on/off depending on the current conditions. This switching can be done dynamically by the digital signal processing (DSP) in the BS and requires no additional network reconfiguration.

A radio transmitter or a network element may be implemented in accordance with any of the embodiments of the invention. Furthermore, modifications of and variations to the embodiments described in this detailed description are also possible.

In transmitting information using the selected transmit diversity order and transmit diversity branches, the power allocation to the branches is preferably even. An even power allocation results in a near-optimum diversity scheme.

In a transmitting arrangement the selection of transmit diversity order and transmit diversity branches may be adapted to be performed in accordance with any of the above mentioned embodiments. Furthermore, it is evident to a person skilled in the art that it is possible to modify those embodiments, where reference is made to a transmit diversity performance indicator or a power threshold criterion relating Rayleigh fading, to utilize a different transmit diversity performance indicator or power threshold criterion.

An example of an alternative utilisation of the proposed transmit diversity order selection can be an automatized base station deployment. An operator does not have to decide in advance if a base station is going to operate in beamforming or in diversity mode all the time. After collecting enough statistical information of multiple mobile radio links, the base station can decide itself by means of transmit diversity performance indicators or a power threshold criterion. This decision is performed autonomously, without any human interaction. When the proposed diversity branch and order selection is used this way, the transmit diversity order and the transmit diversity branch set is determined for the transmitter, for use with any receiver. The specific details of the transmit diversity branch and order selection may be any discussed above.

It is appreciated that the discussed transmit diversity order selection and also the selection of which transmit diversity branches to use is applicable with any transmit diversity technique. For example, the embodiments of the invention are applicable in connection with delay transmit diversity, frequency diversity, space-time codes, or different CDMA codes.

Some embodiments of the invention are described above with reference to a cellular mobile communication system, but it is appreciated that the invention is applicable for selection of transmit diversity order, and preferably also for selection of the transmit diversity branches to be used, for any transmitter having at least two transmit diversity branches. The reference to the downlink direction in connection with base stations is to be understood as a reference to transmit direction, and reference to uplink direction is to be understood as a reference to reception direction.

Determining transmit diversity order and also transmit diversity branches for use may be receiver specific (that is, in some embodiments mobile station specific), communication link specific or channel specific and may be performed independently of other receivers, communications links or channels. The effect of the radio channel is taken into account by the estimated second order statistics. During a communication connection, it is possible to adapt the transmit diversity order, and consequently also the transmit diversity branches, to changing conditions. The transmission scheme could be adapted, for example, if the propagation environment changes due to movements of a transmitter, receiver or scatterer.

It is appreciated that having a transmit diversity order equal to one means using no transmit diversity. In this case, usually the strongest diversity branch is selected for transmission. Alternatively, as mentioned above, beamforming or other method may be used for transmission for increasing the link gain.

It is also appreciated that a number of antennas in a transmitter may be smaller than the number of diversity branches, which may be used in the transmitter. Using polarization diversity as an example, signals corresponding to two (or three) polarization diversity branches may be transmitted from a single antenna.

Although preferred embodiments of the apparatus and method embodying the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

1. Method for determining transmit diversity for a transmitter having at least two transmit diversity branches, the method comprising the step of:
determining at least one transmit diversity branch for use based on estimated channel properties of transmit diversity branches.

2. A method as defined in claim 1, wherein the step of determining comprises determining the at least one transmit diversity branch for use using a transmit diversity performance indicator defined for a transmit diversity branch set, the transmit diversity performance indicator being dependent on at least estimated channel properties of transmit diversity branches belonging to the transmit diversity branch set.

3. A method as defined in claim 2, wherein the step of determining comprises using the transmit diversity performance indicator taking into account one or more of the following:
small-scale fading statistics, and specific channel coding.

4. A method as defined in claim 1, wherein the step of determining the at least one transmit diversity branch for use comprises taking into account a required outage probability.

5. A method as defined in claim 1, wherein the step of determining comprises determining the at least one transmit diversity branch for use based on said estimated channel properties comprising expected powers of transmit diversity branches.

6. A method as defined in claim 5, wherein the step of determining comprises evaluating a transmit diversity performance indicator using said expected powers.

7. A method as defined in claim 6, wherein the step of determining comprises calculating the transmit diversity performance indicator using the following formula:
$${μ}_{k} = \sqrt[k]{{F}_{0} {\prod }_{m = 1}^{k} {λ}_{m}} ,$$
where F₀ denotes the required outage probability, λₘ denotes the expected power of an m-th transmit diversity branch in a transmit diversity branch set Θ, and Θ is the number of transmit diversity branch indexes in the transmit diversity branch set Θ.

8. A method as defined in claim 6, further comprising the steps of:
evaluating said transmit diversity performance indicator for various transmit diversity branch sets and
selecting for use the transmit diversity branch set having an optimum transmit diversity performance indicator value.

9. A method as defined in claim 8, wherein the step of evaluating comprises evaluating said transmit diversity performance indicator for transmit diversity branch sets using a tree structure, a transmit diversity branch set relating to a child node having less transmit diversity branches than a transmit diversity branch set relating to a parent node of the child node.

10. A method as defined in claim 6, wherein the step of determining comprises evaluating the transmit diversity performance indicator defining a branch power threshold for adding a further transmit diversity branch to a transmit diversity branch set for use, the branch power threshold being dependent on the expected powers of the transmit diversity branches already selected to the transmit diversity branch set for use.

11. A method as defined in claim 10, wherein the step of determining comprises selecting the transmit diversity branches to the transmit diversity branch set for use in an order in accordance with estimated expected powers.

12. A method as defined in claim 1, wherein the step of determining comprises determining the at least one transmit diversity branch for use based on the estimated channel properties comprising second order statistics of channel coefficients of transmit diversity branches.

13. A method as defined in claim 12, wherein the step of determining comprises evaluating a transmit diversity performance indicator using said second order statistics.

14. A method as defined in claim 12, wherein the step of determining comprises using the second order statistics comprising at least one correlation matrix calculated using estimated channel coefficients.

15. A method as defined in claim 14, wherein the step of determining comprises calculating the transmit diversity performance indicator using the following formula:
$${μ}_{Θ} = \sqrt[\vert Θ \vert]{{F}_{0} {\prod }_{m = 1}^{\vert Θ \vert} {u}_{m}} ,$$
where F₀ denotes the required outage probability, uₘ denotes an m-th Eigenvalue of a correlation matrix relating to a transmit diversity branch set Θ, and Θ is the number of transmit diversity branch indeces in the transmit diversity branch set Θ.

16. A method as defined in claim 13, further comprising:
evaluating said transmit diversity performance indicator for various transmit diversity branch sets and
selecting for use the transmit diversity branch set having an optimum transmit diversity performance indicator value.

17. A method as defined in claim 16, wherein the step of evaluating comprises evaluating said transmit diversity performance indicator for transmit diversity branch sets using a tree structure, a transmit diversity branch set relating to a child node having less transmit diversity branches than a transmit diversity branch set relating to a parent node of the child node.

18. A method as defined in claim 12, further comprising:
constructing virtual transmit branches as linear combinations of physical transmit diversity branches, and wherein the estimated channel properties comprise expected powers of said virtual transmit branches.

19. A method as defined in claim 18, wherein the step of constructing comprises constructing the virtual transmit branches as Eigenvectors of a channel correlation matrix derived from estimated channel coefficients and expected powers of the virtual transmit branches are determined as Eigenvalues of respective Eigenvectors.

20. A method as defined in claim 18, wherein the step of determining comprises determining the at least one transmit diversity branch using a transmit diversity performance indicator defining a branch power threshold for adding a further virtual transmit branch set for use, the branch power threshold being dependent on the expected powers of the virtual transmit branches already selected to the virtual transmit branch set for use.

21. A method as defined in claim 20, wherein the step of determining comprises selecting the virtual transmit branches to the virtual transmit branch set for use in an order in accordance with respective expected powers.

22. A method as defined in claim 1, further comprising:
allocating transmission power evenly to physical transmit diversity branches or virtual transmit diversity branches selected for use.

23. A method as defined in claim 1, further comprising:
transmitting information using transmit diversity branches selected for use.

24. A method as defined in claim 1, further comprising:
estimating channel properties using channel coefficients at a transmitter.

25. A method as defined in claim 1, further comprising:
estimating channel properties using channel coefficients at a receiver.

26. A method as defined in claim 1, wherein the step of determining comprises determining the at least one transmit diversity branch for use for a receiver independently of other receivers.

27. A method as defined in claim 1, wherein the step of determining comprises determining the at least one transmit diversity branch for a radio link independently of other radio links employed by a transmitter.

28. A method as defined in claim 1, wherein the step of determining comprises determining the at least one transmit diversity branch for use for a transmitter, for use with a receiver.

29. A network element for use in transmit diversity, the network element comprising:
establishing means for establishing estimated channel properties of at least two transmit diversity branches, and
determining means for determining transmit diversity branches for use based on the estimated channel properties.

30. A network element as defined in claim 30, the network element further comprising said at least two transmit diversity branches and transmitting means for transmitting information over a radio interface using selected transmit diversity branches.

31. A network element as defined in claim 31, said network element comprising a base station of a cellular communications system.

32. A network element as defined in claim 30, said network element comprising a base station controller of a cellular communications system.

33. A network element as defined in claim 31, said network element comprising an access point of a wireless local area network.

34. A radio transmitter having at least two transmit diversity branches, the radio transmitter comprising:
establishing means for establishing estimated channel properties of at least two transmit diversity branches, and
determining means for determining transmit diversity branches for use based on the estimated channel properties.

35. A radio transmitter as defined in claim 35, the radio transmitter comprising a mobile station for a cellular telecommunications network.

36. A radio transmitter as defined in claim 35, the radio transmitter comprising user equipment of a wireless local area network.
